(19) United States
(12) Patent Application Publication
(10) Pub. No.: US 2026/0363158 A1
(43) Pub. Date: Nov. 19, 2026

(54) GARDEN HOE

(71) Applicant: Chris Engelbrecht, Chicago, IL (US)

(72) Inventor: Chris Engelbrecht, Chicago, IL (US)

(21) Appl. No.: 19/677,966

(22) Filed: May 14, 2026

Related U.S. Application Data
(60) Provisional application No. 63/805,577, filed on May 14, 2025.

(51) Int. Cl. A01B 1/08

(52) U.S. Cl. CPC A01B 1/08

(57) ABSTRACT

A garden tool is provided that can be used to break up and move soil with ease. In some embodiments, the garden tool comprises a garden hoe having a blade and a handle. The blade includes a head and a neck, the head having a cut out at a proximal end, a compound curve, and a point at a distal end. The point breaking soil against which it is impacted. The curve facilitates lifting of soil. The cut out facilitates flow of soil over the tool as the tool is moved through soil.

### CROSS-REFERENCE TO RELATED APPLICATIONS

This application claims the benefit of and priority to U.S. Provisional Patent Application Ser. No. 63/805,577 filed May 14, 2025, the disclosure of which is herein incorporated by reference in its entirety.

### FIELD OF THE INVENTION

The present disclosure relates to a novel and advantageous garden tool. Particularly, the present disclosure relates to a novel and advantageous garden hoe having a blade and a handle. More particularly, the present disclosure relates to a novel and advantageous garden hoe having a blade and a handle, the blade including a head and a neck, and the head having a cut out at a proximal end, a compound curve, and a point at a distal end.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Various garden tools such as garden hoes have been known in the art for gardening and farming. Garden hoes are commonly used for removing weeds, shaping soil 138 and digging trenches or furrows for planting bulbs or seeds. Weeding with a hoe includes chopping foliage from roots and clearing soil of crop residues or old roots.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure includes improvements over the current state of the art.

The present disclosure is generally directed to garden tools, and more particularly toward novel implementations of a garden tool that can be used to break up and move soil with ease. In some embodiments, the garden tool comprises a garden hoe having a blade and a handle. The blade includes a head and a neck, the head having a cut out at a proximal end, a compound curve, and a point at a distal end. The point breaking soil against which it is impacted. The curve facilitates lifting of soil. The cut out facilitates flow of soil over the tool as the tool is moved through soil.

In one aspect, the present disclosure provides a garden tool, comprising a handle having a proximal end and a distal end and a blade having a neck and a head. The neck has a distal portion and an engagement portion, wherein the engagement portion engages the distal end of the handle and the distal portion adjoins the head. The head has a triangular body, a first tab, a second tab, a cut out portion between the first tab and the second tab, and a point. The head further has a compound curvature.

The present disclosure further provides a method of using the garden tools set forth herein, with the method comprising forming an initial fracture point in soil using the point of the garden tool, and advancing the head of the tool into the soil to cause the soil to uplift.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the method and system of the disclosure. Together with the description, the drawings serve to explain the principles of the disclosed embodiments.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 depicts an isometric view of an illustrative garden hoe, in accordance with one embodiment.

FIG. 2 depicts a close-up view of a distal end of a handle, a neck portion and, a head of the garden tool of FIG. 1.

FIG. 3 depicts an alternate view of the head and neck of the garden tool of FIG. 1.

FIG. 4a depicts a further view of the head and neck of the garden tool of FIG. 1.

FIG. 4b illustrates an alternative view of the portion of the garden tool shown in FIG. 4a.

FIG. 5 depicts a view of the head of the garden tool of FIG. 1.

FIG. 6 depicts an alternative view of the head of the garden tool of FIG. 1, particularly illustrating a second edge of the head, and illustrating a further aspect of compound curvature of the head along a lengthwise direction of the head.

### DETAILED DESCRIPTION

The present disclosure is generally directed to garden tools, and more particularly toward novel implementations of a garden tool that can be used to break up and move soil with ease. In some embodiments, the garden tool comprises a garden hoe having a blade and a handle. The blade includes a head and a neck, the head having a cut out at a proximal end, a compound curve, and a point at a distal end. The point breaking soil against which it is impacted. The curve facilitates lifting of soil. The cut out facilitates flow of soil over the tool as the tool is moved through soil.

The handle of the tool has a length suitable for a user to be able to grip the tool and obtain the proper head angle to the ground without excessive bending of the torso. The handle has a diameter shaped and sized to provide a comfortable gripping surface. The handle is light weight and may be formed of wood, plastic, composite, or other suitable material.

The head and neck may be unitary or may be separate and coupled. The blade of the tool, including the neck and the head, may be formed from metal, such as steel or aluminum, or other suitable material.

The head of the tool includes a cut out along a proximal portion thereof and tapers to a point at its distal end. In use, the point can be used to create a small initial fracture in soil to allow the rest of the head to move under the surface of the soil. The head has a width and a length. The head has a compound curvature to facilitate lifting of soil. The compound curve includes a curve along the width of the head and an upsweep towards the neck. The curvature may be such that uplift of soil occurs but the soil does not bunch up and drag. The neck may also include a curvature. An upper portion of the head opposite the point can be cut out or otherwise removed to facilitate flow of soil over the tool as the tool is moved through the soil. This permits long sweeps of the tool to be made through the soil. A uniqueness of the curvature of the tool is that the tool can be turned 90 degrees with the point down and a shallow furrow can be made for seed placement. Moreover, the face of the head can be placed flatly against the soil surface to allow for a shallow sweeping motion.

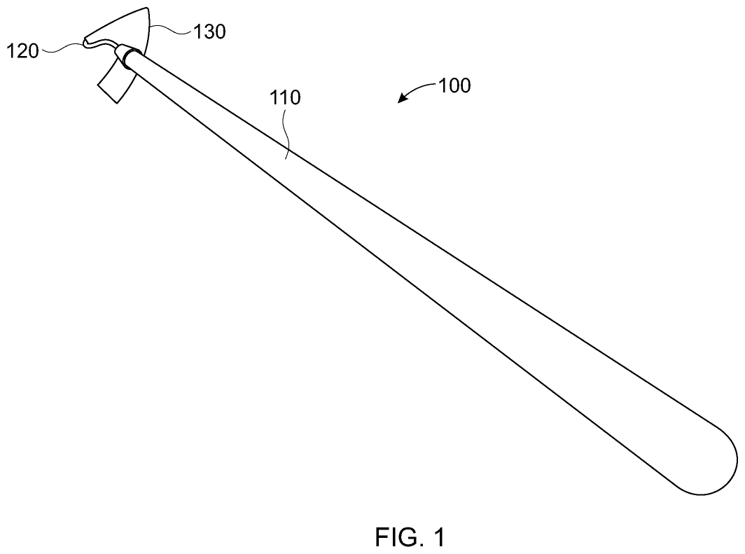

FIG. 1 shows a garden tool, in accordance with one embodiment. As shown, the tool 100 includes an elongate handle 110 and a blade. The blade comprises a head 130 and a neck 120. The elongate handle 110 has a proximal end nearest the user (referred to as a first end) and a distal end for engaging soil (referred to as a second end). The neck 120 has a proximal portion (referred to as a first portion) and a distal portion (referred to as a second portion). The neck 120 attaches to the handle 110 at an engagement portion and extends distally from the distal end of the handle. The distal portion of the neck 120 adjoins the head 130. The neck 120 may be integral with the head 130 or may be coupled to the head 130, through, e.g., friction fit, fastening, adhering, and other fixation mechanisms. The second portion of the neck 120 is oriented obliquely or perpendicularly with respect to the first portion of the curved neck 120 to permit the head 130 to be oriented obliquely or perpendicularly with respect to the handle 110.

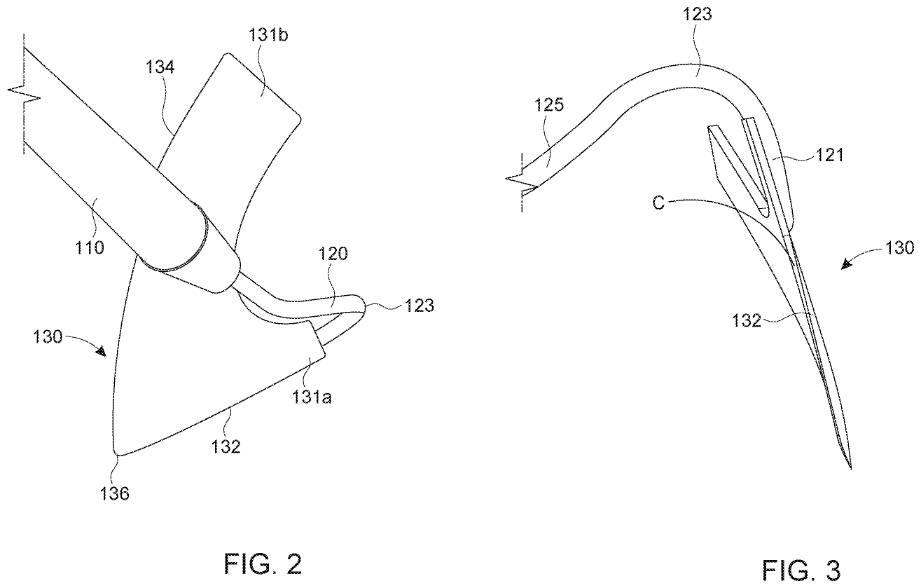

FIG. 2 is a close-up view of the distal end of the handle 110, the neck 120, and the head 130 of the garden tool of FIG. 1. FIG. 3 is an alternate view of the head 130 and neck 120 of the garden tool of FIG. 1. As best seen in FIG. 3, the neck 120 includes a distal portion 121, a curvature 123, an extension 125, and an engagement portion 127. The engagement portion 127 engages the handle 110. The head 130 comprises a triangular body 133 having a first edge 132 and a second edge 134, a first tab 131a, and a second tab 131b, and a cut out portion 139 between the first and second tabs 131a, 131b. The head 130 terminates in a point 136. The distal portion of the neck 120 may adjoin the head 130 at the first tab 131a.

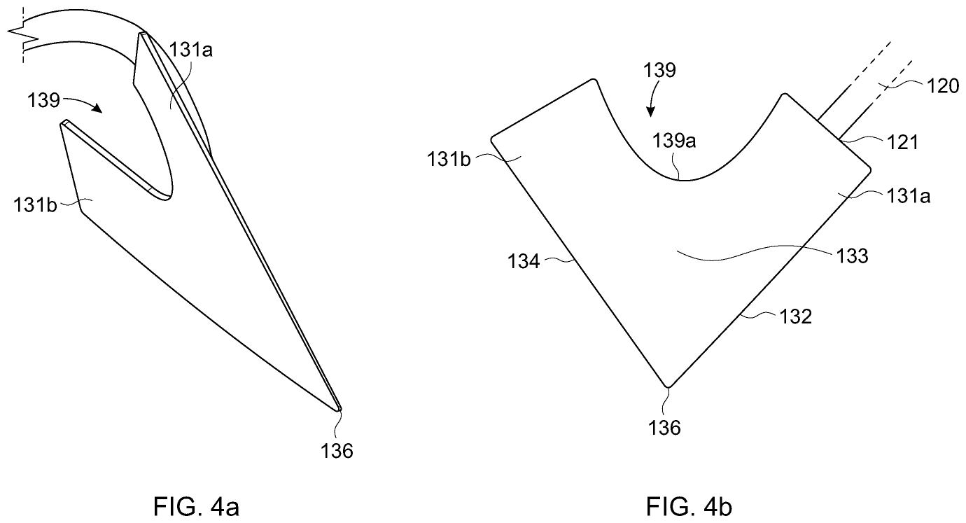

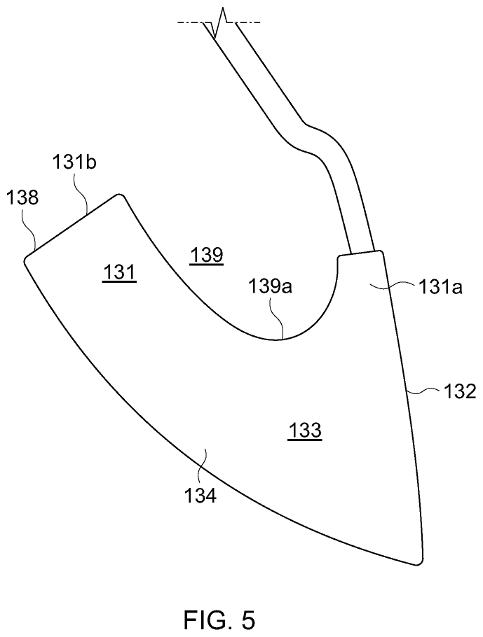

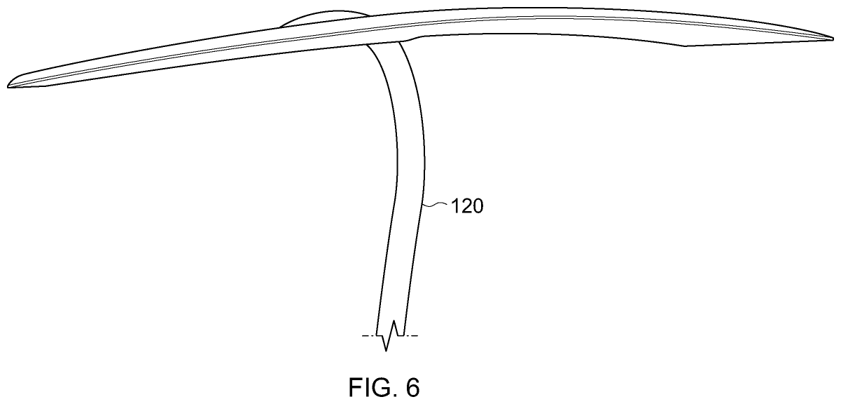

FIG. 3 further illustrates curvature C extending laterally across the head 130 of the garden tool. The compound curvature along more than one dimension results in a concave surface on the front and back surfaces of the head 130, wherein the concavity faces toward the left in FIG. 3 and toward the viewer in FIG. 2. FIGS. 4a and 4b depict a further view of the head 130 of the garden tool 100 of FIG. 1. FIG. 5 depicts a front view of the head 130 of the garden tool of FIG. 1. FIG. 6 depicts a side view of the head 130 of the garden tool of FIG. 1, and illustrating a further aspect of compound curvature of the head along a lengthwise direction of the head, as indicated in the Figure.

As depicted in the Figures, the head 130 has a main body portion 133, a first tab 131a,, and a second tab 131b, with a cut out portion 139 (e.g., a notch) between the first and second tabs 131a, 131b. The neck 120 may intersect the head at first tab 131a. The head is defined by a first edge 132 and a second edge 134, the first edge 132 extending parallel to and beyond the second portion of the neck 120. The head terminates in point 136, where the first edge 132 intersects the second edge 134, forming a “V” shape. As seen in FIG. 5, each of the first edge 132 and the second edge 134 may be curved, forming convex edges of the head in a planar projection of the head 130 on a flat surface, for purposes of describing the geometry. Moreover, since the head 130 is a planar or plate shaped member with compound curvature, the edges 132, 134 can each be provided with a compound curvature when viewing the head 130 along the edge, as illustrated by way of edge 132 in FIG. 3.

FIGS. 4a and 4b depict a further view of the head 130, particularly illustrating the body 133, first tab 131a, second tab 131b, and cut out portion 139. As shown, the first and second tabs 131a, 131b extend away from the point 136 of the head 130. Cut out portion 139 is defined by a curved edge 139a along an inner edge of the head 130 and unfilled space between the first and second tabs 131a, 131b. As such, the cut out portion 139 is located within the “V” shape of the head 130. In other embodiments, the cut out portion is also substantially “V” shaped, with the intersecting linear edges replacing the curved edge 139a. Other shapes for the cut out portion 139 are within the scope of the disclosure.

The head 130 can be formed by a generally planar piece of material having a compound curvature along the generally planar piece of material. The first edge 132 can have a first end that overlaps with the neck 120 and a second end that terminates in point 136. The generally planar piece of material can have a curved cross section along a direction from the first end of the first edge 132 to the second end of the first edge 132. Similarly, the second edge 134 can have a first, free end 138, and a second end that terminates in point 136. The generally planar piece of material can have a curved cross section along a direction from the first end of the first edge 132 to the first end of the second edge 134. For example, the first edge 132 and second edge 134 can each be curved to form an arc, 2D curve, or compound curve in three dimensions. In some embodiments, the first edge 132 and the second edge 134 may have equal lengths. In other embodiments, the second edge 134 may be longer than the first edge 132 or the first edge 132 may be longer than the second edge 134.

Various implementations of a method are provided herein of using the disclosed garden tool. One method can include forming an initial fracture point in soil using the point of the garden tool, and advancing the head of the tool into the soil to cause the soil to uplift. The compound curvature of the head causes soil to uplift as the tool is moved through the soil, but does not cause soil to bunch up.

This tool is preferably a fitted tool but the fitting of the tool is not unique to its use. The fitting preferably takes into account the users overall height or the distance from their palm to the ground. This fitting reduces back strain by allowing the user to obtain the proper head angle to the ground without excessive bending over of the torso.

The devices and methods disclosed herein can be used for other purposes as illustrated or can be modified as needed to suit the particular application. In view of the many possible embodiments to which the principles of this disclosure may be applied, it should be recognized that the illustrated embodiments are only preferred examples of the disclosure and should not be taken as limiting the scope of the disclosure.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A garden tool, comprising:
a handle having a proximal end and a distal end;
a blade having a neck and a head, wherein:
the neck has a distal portion and an engagement portion, wherein the engagement portion engages the distal end of the handle and the distal portion adjoins the head;
the head has a triangular body, a first tab, a second tab, a cut out portion between the first tab and the second tab, and a point, wherein the head has a compound curvature.

2. The garden tool of claim 1, wherein the distal portion of the neck adjoins the head at the first tab.

3. The garden tool of claim 2, wherein the head has a first edge that extends parallel to and beyond the distal portion of the neck terminating at the point, and a second edge that intersects the first edge at the point.

4. The garden tool of claim 1, wherein the head is formed by a generally planar piece of material having a compound curvature along the generally planar piece of material.

5. The garden tool of claim 4, wherein the first edge has a first end that overlaps with the neck, and a second end that coincides with the point, and further wherein the generally planar piece of material has a curved cross section along a direction from the first end of the first edge to the second end of the first edge.

6. The garden tool of claim 5, wherein the second edge has a first, free end, and a second end that coincides with the point, and further wherein the generally planar piece of material has a curved cross section along a direction from the first end of the first edge to the first end of the second edge.

7. The garden tool of claim 6, wherein the first edge and second edge are each curved.

8. The garden tool of claim 6, wherein the second edge is longer than the first edge.

9. The garden tool of claim 6, wherein a length of the first edge is equal to a length of the second edge.

10. The garden tool of claim 1, wherein the neck further includes a curvature and an extension.

11. A method of using the garden tool of claim 1, comprising forming an initial fracture point in soil using the point of the garden tool, and advancing the head of the tool into the soil to cause the soil to uplift.

12. The method of claim 11, further wherein the compound curvature of the head causes soil to uplift as the tool is moved through the soil, but does not cause soil to bunch up.

13. A garden tool, comprising:
a handle having a proximal end and a distal end;
a blade having a neck and a head, wherein:
the neck has a distal portion and an engagement portion, wherein the engagement portion engages the distal end of the handle and the distal portion adjoins the head;
the head has a triangular body, a first tab, a second tab, and a point, wherein the head is formed by a generally planar piece of material having a compound curvature along the generally planar piece of material.

14. The garden tool of claim 13, wherein the head has a cut out portion between the first tab and the second tab.

15. The garden tool of claim 14, wherein the cut out portion is at least partially defined by a curved edge of the body.
